(19) United States
(12) Patent Application Publication
(10) Pub. No.: US 2008/0237418 A1
(43) Pub. Date: Oct. 2, 2008

(54) Clamp Bench Blocks

(75) Inventor: Steven D. Krohmer, Coon Rapids, MN (US)

Correspondence Address: WESTMAN CHAMPLIN & KELLY, P.A., SUITE 1400, 900 SECOND AVENUE SOUTH, MINNEAPOLIS, MN, 55402-3244, US

(73) Assignee: ROCKLER COMPANIES, INC., Medina, MN (US)

(21) Appl. No.: 11/863,836

(22) Filed: Sep. 28, 2007

Related U.S. Application Data
(60) Provisional application No. 60/827,303, filed on Sep. 28, 2006.

(51) Int. Cl. F16M 13/00

(52) U.S. Cl. 248/200

(57) ABSTRACT

A device for holding a clamp is provided including a housing and a first clamp holding mechanism positioned in the housing. A second clamp holding mechanism is also positioned in the housing and is orthogonal to the first clamp holding mechanism.

### CROSS-REFERENCE TO RELATED APPLICATION

The present application is based on and claims the benefit of U.S. provisional patent application Ser. No. 60/827,303, entitled “CLAMP BENCH BLOCKS” filed Sep. 28, 2006, the content of which is hereby incorporated by reference in its entirety.

### BACKGROUND

Clamps are used in a variety of applications for holding work pieces. Two such clamps include bar clamps and pipe clamps. Current bar and pipe clamps include a beam (which can be a bar or a pipe) and first and second jaws positioned on the beam. One or both of the jaws can be adjustably positioned along a length of the beam. In some situations, for example, when assembling doors or frames, multiple clamps can be used to apply pressure at multiple angles with respect to the work piece. Holding and working with multiple clamps in an application can be difficult and cumbersome.

The discussion above is merely provided for general background information and is not intended to be used as an aid in determining the scope of the claimed subject matter.

### SUMMARY

A device for holding a clamp is disclosed that includes a housing with a first clamp holding mechanism positioned in the housing. A second clamp holding mechanism is also positioned in the housing and is orthogonal to the first clamp holding mechanism.

A method of holding first and second pipe clamps is also disclosed. The method includes providing a housing and first and second clamp holding mechanisms in the housing. The second clamp holding mechanism is positioned orthogonal to the housing.

An assembly is also disclosed that includes a bench block with a housing positioned on a surface. First and second clamp holding mechanisms are positioned in the housing. A first clamp is positioned in the first clamp holding mechanism and a second clamp is positioned in the second clamp holding mechanism. The second clamp is orthogonal to the first clamp.

This Summary is provided to introduce some concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION

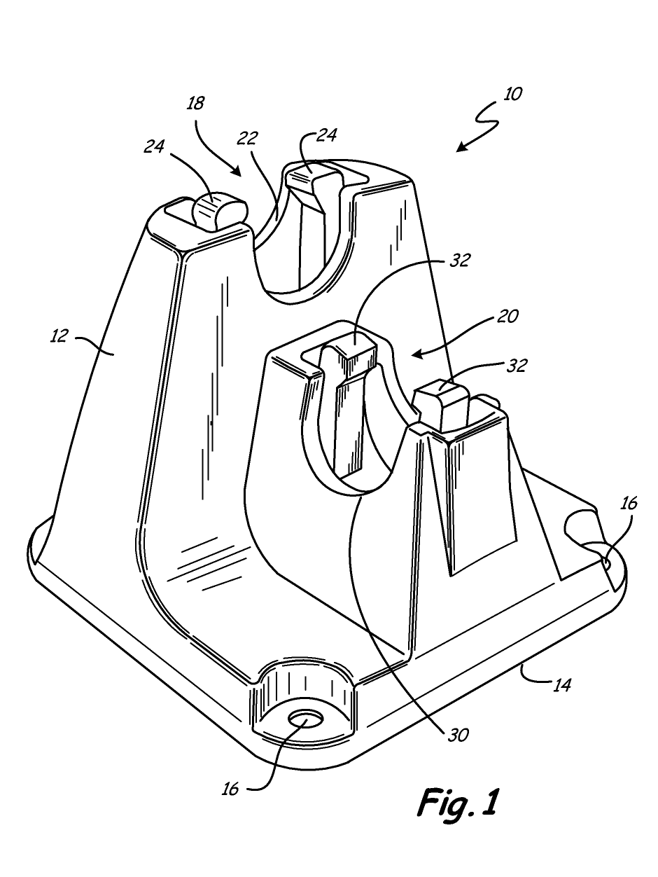

FIG. 1 is an isometric view of a bench block.

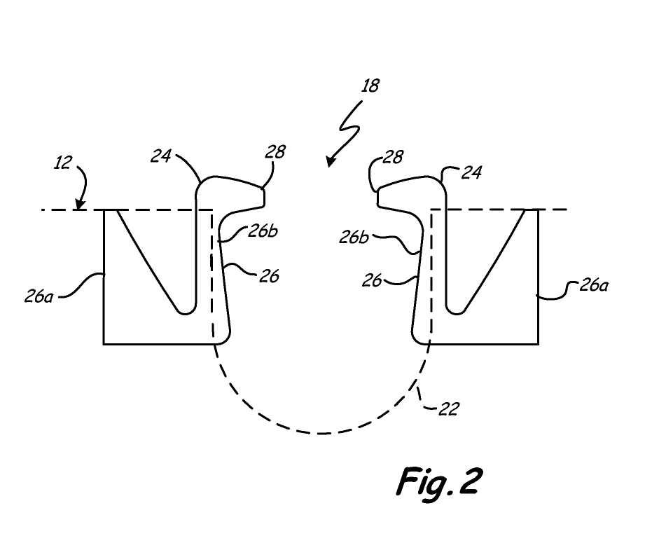

FIG. 2 is a schematic view of a clamp holding mechanism.

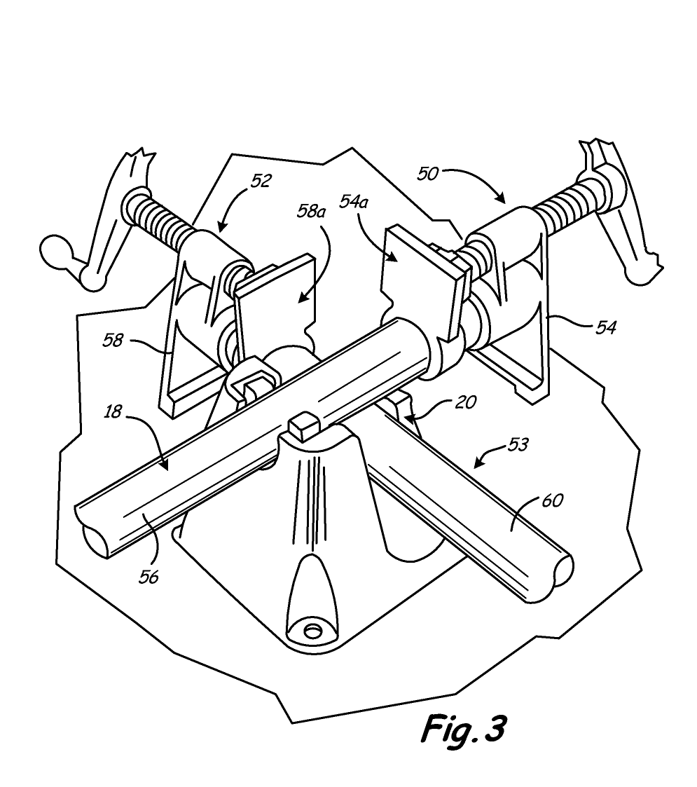

FIG. 3 is an isometric view of a bench block holding two pipe clamps that are positioned orthogonal with respect to one another.

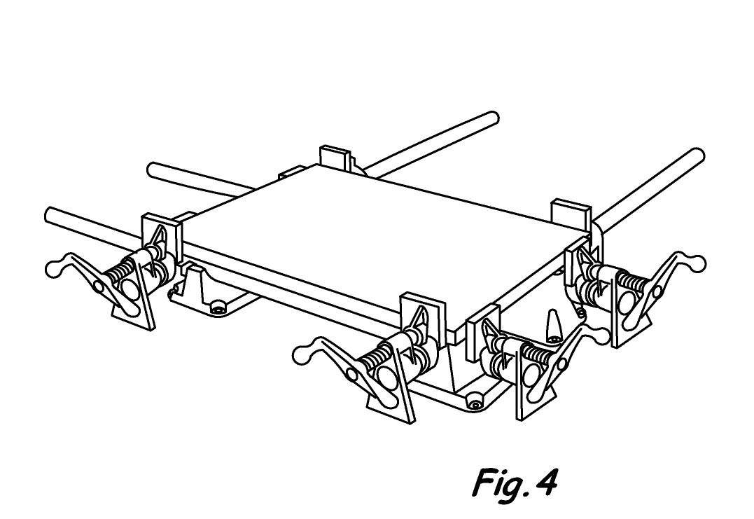

FIG. 4 is an isometric view of four bench blocks and four pipe clamps positioned within the four bench blocks and having a work piece disposed therebetween.

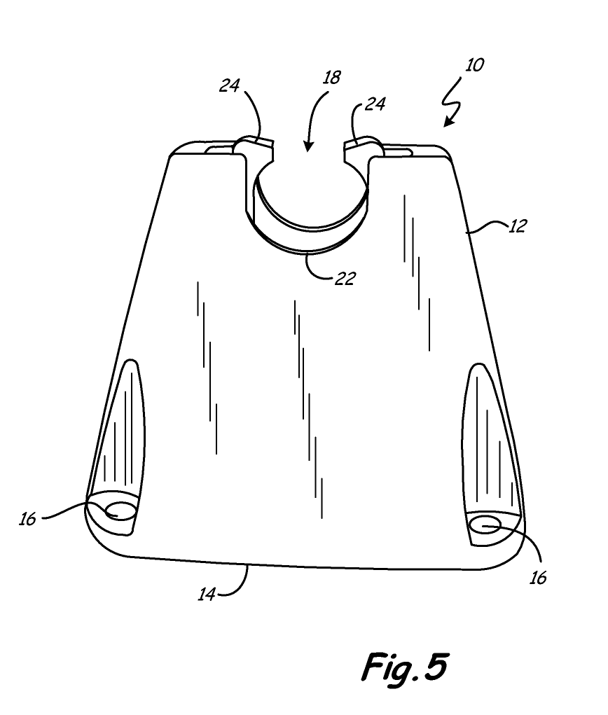

FIG. 5 is a rear view of a bench block.

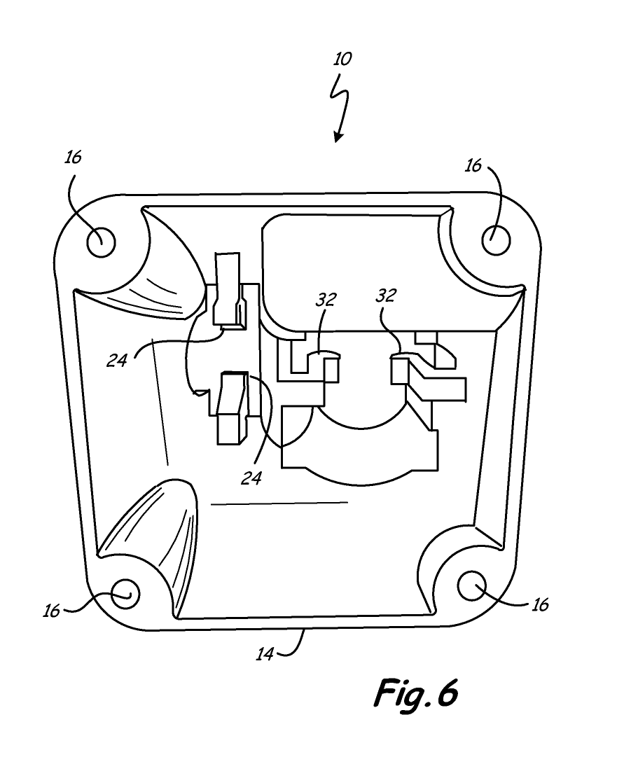

FIG. 6 is a bottom view of a bench block.

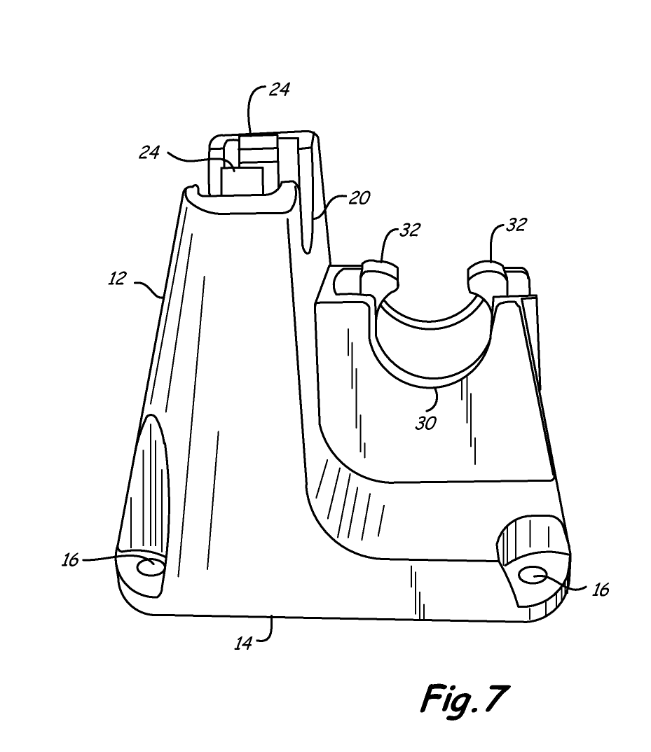

FIG. 7 is a side view of a bench block.

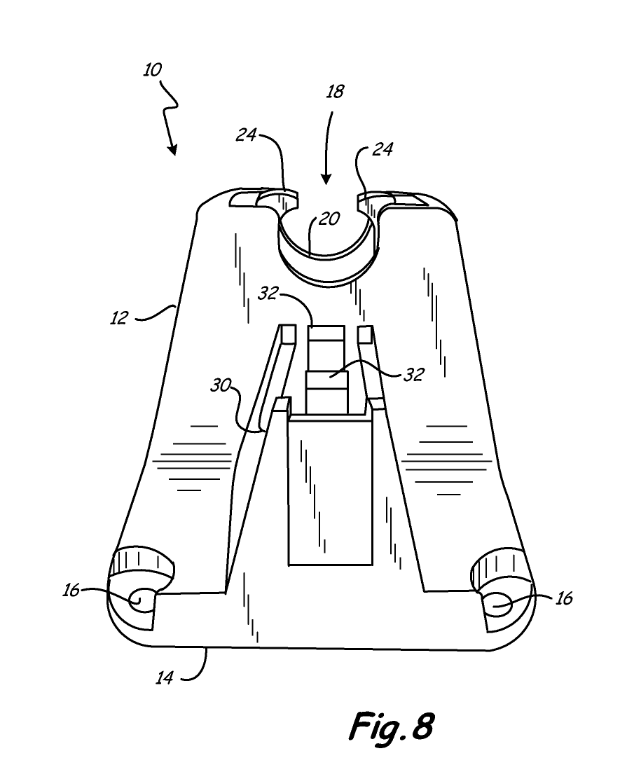

FIG. 8 is a front view of a bench block.

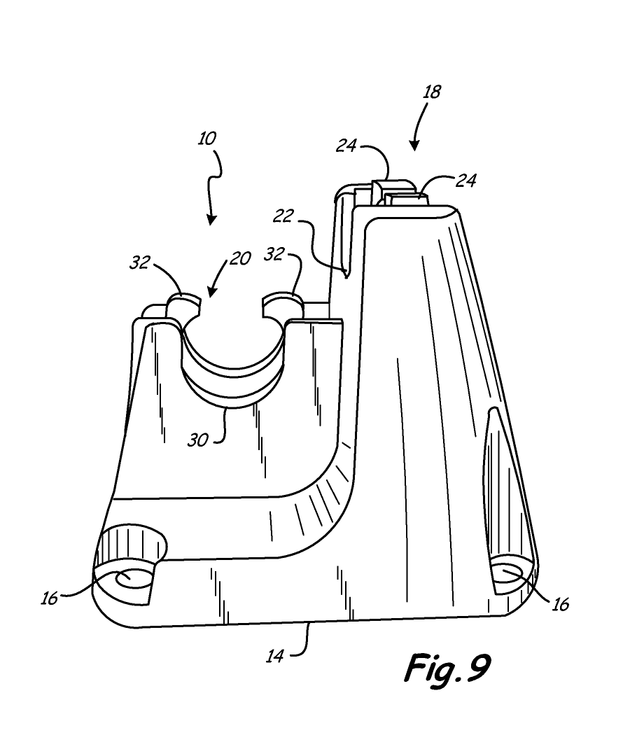

FIG. 9 is a side view of a bench block.

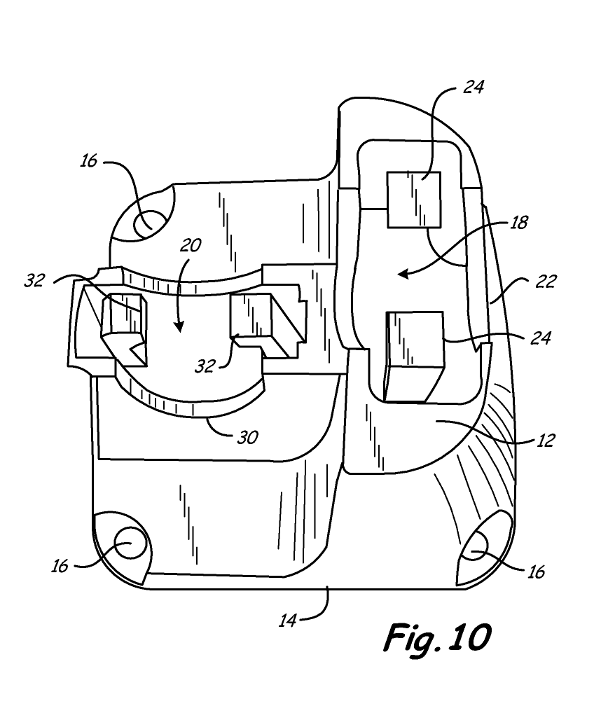

FIG. 10 is a top view of a bench block.

### DETAILED DESCRIPTION

FIG. 1 illustrates a bench block 10 having a housing 12. Housing 12 includes a base portion 14 adapted to set flush with respect to a bench or work surface. Base portion 14 includes a plurality of mounting holes 16 adapted to receive fasteners (e.g. screws, bolts, nails) that can mount bench block 10 to a bench of a work surface. Housing 12 further includes a first clamp holding mechanism 18 and a second clamp holding mechanism 20. FIGS. 5-10 illustrate various views of a bench block. As illustrated, bench block 10 includes an opening (FIG. 6) to receive similarly configured bench blocks to stack the bench blocks for storage and/or shipping.

First clamp holding mechanism 18 and second clamp holding mechanism 20 are positioned such that respective beam receiving portions are positioned orthogonal with respect to one another. Additionally, first clamp holding mechanism 18 and second clamp holding mechanism 20 are positioned at different heights with respect to base portion 14. In one embodiment, a height of second clamp holding mechanism 20 can be chosen such that a bottom surface of feet of a corresponding clamp held therein is co-planar with a bottom surface of base 14. A difference in height between first clamp holding mechanism 18 and second clamp holding mechanism 20 can be sufficient enough to allow for clearance of beams held by mechanism 18 and 20.

Clamp receiving mechanism 18 includes a receiving portion 22 and a set of clips 24 positioned on either side of receiving portion 22. Receiving portion 22 is round to receive a round pipe of a pipe clamp, although other shapes can be used as desired. Clips 24 can be formed integrally with housing 12 and can actuate toward and away from each other in order to grip a beam positioned therebetween. The clips 24 can tightly grip the beam to prevent rotation of the beam with respect to bench block 10.

As further schematically illustrated in FIG. 2, clips 24 include arms 26 and opposed tabs 28 that face each other. Arms 26 include a portion 26a that is secured to housing 12 and a portion 26b that is spaced apart from the portion 26a to allow deflection thereof. In operation, a beam is positioned between clamps and urges portions 26b toward portions 26a. The resiliency of portions 26b can hold the beam in place while tabs 28 rest on top of the beam. Alternatively, one of the clips 24 can be stationary with respect to housing 12. If desired, clips 24 can include a surface to frictionally engage a beam. In one example, clips 24 can include a resilient surface such as rubber to aid in gripping a beam of a clamp. Similarly, clamp receiving mechanism 20 includes a receiving portion 30 and opposed clips 32.

Bench block 10 can be made of a fiber glass reinforced plastic. Additionally, bench block 10 can be hollow such that additional bench blocks can be stacked with respect to one another for storage and/or convenient shipping. The bench blocks can be grouped in sets of four to provide a set for assembly of doors or frames.

FIG. 3 illustrates bench block 10, holding clamps 50 and 52 on a work surface 53. Clamp 50 includes a jaw 54 and pipe 56. Similarly, clamp 52 includes a jaw 58 and a pipe 60. Pipe 56 and pipe 60 are positioned in clamp holding mechanism 18 and clamp holding mechanism 20, respectively. Since clamp holding mechanism 18 and clamp holding mechanism 20 are oriented orthogonal to one another, pipes 56 and 60 are oriented orthogonal to one another. More particularly, jaw 54 includes a face 54a that is perpendicular to a face 58a of jaw 58. Thus, a workpiece such as a door or frame can be positioned to abut faces 54a and 58a so the workpiece is held in place. Clamp holding mechanism 18 is positioned at a height such that jaw 58 rests on work surface 53. Additionally, clamp holding mechanism 20 is positioned at a height above clamp holding mechanism 18 to allow clearance for pipe 56.

FIG. 4 illustrates four bench blocks in a rectangular arrangement in a rectangular arrangement holding four clamps having a workpiece disposed therebetween. Each bench block supports two clamps positioned orthogonal to each other. The workpiece is thus held at all four of its corners, which can make it easy to work with, such as to sand, cut, glue, etc.

Although the subject matter has be described in language specific to various features and/or acts, it is to be understood that the subject matter defined in the appended claims is not necessarily limited to the specific features or acts described above. Rather, the specific features and acts describe above are disclosed as example forms of implementing the claims.

What is claimed is:

1. A device for holding a clamp, comprising:
a housing;
a first clamp holding mechanism positioned in the housing and adapted to exert pressure on a beam of a clamp while the beam is positioned therein; and
a second clamp holding mechanism positioned in the housing and orthogonal to the first clamp holding mechanism, the second clamp holding mechanism adapted to exert pressure on a beam of a clamp while the beam is positioned therein.

2. The device of claim 1 wherein the first clamp holding mechanism includes a first receiving portion and the second clamp holding mechanism includes a second receiving portion.

3. The device of claim 2 wherein the first receiving portion and the second receiving portion are round to receive a pipe of a pipe clamp.

4. The device of claim 3 wherein the first clamp holding mechanism includes a first set of clips positioned in the first receiving portion and the second clamp holding mechanism includes a second set of clips positioned in the second receiving portion.

5. The device of claim 4 wherein the first set of clips includes a set of arms spaced apart from the housing, each arm including a tab extending from the arm and wherein the second set of clips includes a set of arms spaced apart from the housing, each arm including a tab extending from the arm.

6. The device of claim 4 wherein the first receiving portion is positioned at a different height than the second receiving portion with respect to the base.

7. The device of claim 1 wherein the housing includes a base adapted to be positioned flush on a flat surface.

8. The device of claim 7 and further comprising a plurality of apertures positioned in the housing for receiving fasteners to mount the housing to the flat surface.

9. A method of holding a first pipe clamp and a second pipe clamp, comprising:
providing a housing;
providing a first clamp holding mechanism positioned in the housing;
providing a first set of clips in the first clamp holding mechanism, the first set of clips being adapted to deflect with respect to the housing when a beam of a clamp is positioned between the clips;
providing a second clamp holding mechanism positioned in the housing orthogonal to the first clamp holding mechanism; and
providing a second set of clips in the second clamp holding mechanism, the second set of clips being adapted to deflect with respect to the housing when a beam of a clamp is positioned between the clips.

10. The method of claim 9 wherein the first clamp holding mechanism includes a round receiving portion and the first set of clips is positioned in the receiving portion and wherein the second clamp holding mechanism includes a round receiving portion and the second set of clips is positioned in the receiving portion.

11. The method of claim 9 wherein the first set of clips includes a first arm having a first potion attached to the housing and a second portion spaced apart from the first portion and the housing.

12. The method of claim 9 wherein the first set of clips includes tabs extending toward each other.

13. The method of claim 9 and further comprising:
providing a plurality of apertures in the housing for receiving fasteners to mount the housing to a flat surface.

14. An assembly, comprising:
a bench block having a housing positioned on a surface with a first clamp holding mechanism having a first set of clips and a second clamp holding mechanism having a second set of clips;
a first clamp positioned in the first clamp holding mechanism such that the first set of clips exert pressure on the first clamp; and
a second clamp positioned in the second clamp holding mechanism such that the second clamp is orthogonal to the first clamp and the second set of clips exert pressure on the second clamp.

15. The assembly of claim 14 wherein the first set of clips include arms that deflect when the first clamp is positioned therebetween and wherein the second set of clips include arms that deflect when the second clamp is positioned therebetween.

16. The assembly of claim 12 wherein the first clamp is positioned at a different height than the second clamp.

17. The assembly of claim 12 and further comprising second, third and fourth bench blocks positioned in a rectangular arrangement with the first-mentioned bench block.

18. The assembly of claim 17 wherein the first clamp is positioned in a clamp holding mechanism of the second bench block and the second clamp is positioned in a clamp holding mechanism of the third bench block.

19. The assembly of claim 18 wherein the first clamp and the second clamp are pipe clamps having a round beam.

20. The assembly of claim 19 wherein the first-mentioned, second, third and fourth bench blocks are mounted to the surface.
